(19) United States
(12) Patent Application Publication
(10) Pub. No.: US 2024/0201026 A1
(43) Pub. Date: Jun. 20, 2024

(54) TEMPERATURE SENSOR AND METHOD OF MANUFACTURING TEMPERATURE SENSOR

(71) Applicant: Yazaki Corporation, Tokyo (JP)

(72) Inventors: Shinpei KATO, Shizuoka (JP); Shingo NOMOTO, Shizuoka (JP); Daichi MURAMOTO, Shizuoka (JP); Shinpei ANDO, Shizuoka (JP)

(73) Assignee: Yazaki Corporation, Tokyo (JP)

(21) Appl. No.: 18/590,321

(22) Filed: Feb. 28, 2024

Related U.S. Application Data
(63) Continuation of application No. PCT/JP23/00704, filed on Jan. 13, 2023.

(30) Foreign Application Priority Data
Feb. 14, 2022 (JP) 2022-020222

(51) Int. Cl. G01K 7/22

(52) U.S. Cl. CPC G01K 7/22

(57) ABSTRACT

A temperature sensor includes a pair of lead frames, a thermistor provided on the pair of lead frames, a first resin part composed of an epoxy resin and covering the thermistor and a part of the pair of lead frames near the thermistor with predetermined rigidity, and a second resin part covering a portion of the first resin part and a part of the pair of lead frames so that a portion of the first resin part near the thermistor is exposed.

### CROSS-REFERENCE TO RELATED APPLICATIONS

The present application is a continuation of International Application No. PCT/JP2023/000704, filed on Jan. 13, 2023, and based upon and claims the benefit of priority from Japanese Patent Application No. 2022-020222, filed on Feb. 14, 2022, the entire contents of which are incorporated herein by reference.

### TECHNICAL FIELD

The present application relates to a temperature sensor and a method of manufacturing a temperature sensor.

### BACKGROUND

JP 2021-067493 A (PTL 1) discloses a temperature sensor in which a temperature detection element (thermistor) and a lead wire are coated with an epoxy resin excellent in heat resistance and chemical resistance.

JP 2001-141573 A (PTL 2) discloses a temperature sensor in which a lead wire part is connected to a heat sensitive element (thermistor), and both are sealed by a sealing layer. The sealing layer is connected to a resin base and a heat transfer agent is provided in a gap between the sealing layer and the resin base.

### SUMMARY

In the temperature sensor described in PTL 1, the temperature detection element (thermistor) and the lead wire are protected by a coating of the epoxy resin. However, the thickness of the epoxy resin is reduced by the coating, and the outer shape of the epoxy resin follows the outer shape of the thermistor and the lead wire. That is, the outer shape of the epoxy resin slightly increases the outer shape of the thermistor and the lead wire.

In the temperature sensor described in PTL 1, the thickness of the epoxy resin to which the coating is applied is reduced, so that the strength of the temperature sensor is reduced. In the temperature sensor described in PTL 2, the heat flowing through the three layers of the resin base, the heat transfer agent and the sealing layer is detected by a thermistor, so that the response is reduced.

It is an object of the present application to provide a temperature sensor which is more responsive than a conventional temperature sensor without reducing its strength.

A temperature sensor according to the present application includes a pair of lead frames, a thermistor provided on the pair of lead frames, a first resin part composed of an epoxy resin and covering the thermistor and a part of the pair of lead frames near the thermistor with predetermined rigidity, and a second resin part covering a portion of the first resin part and a part of the pair of lead frames so that a portion of the first resin part near the thermistor is exposed.

A method for manufacturing a temperature sensor according to the present application includes: a thermistor installation step of installing a thermistor on a pair of lead frames; a first resin part installation step of providing a first resin part having a predetermined rigidity by covering the thermistor and a portion of the pair of lead frames near the thermistor with epoxy resin by use of transfer molding after the thermistor is installed on the pair of lead frames in the thermistor installation step; and a second resin part installation step of providing a second resin part covering a portion of the first resin part and a part of the pair of lead frames by use of insert molding so that a portion of the first resin part near the thermistor is exposed after the first resin part is provided in the first resin part installation step.

### BRIEF DESCRIPTION OF THE DRAWINGS

FIG. 1 is a perspective view of a temperature sensor according to an embodiment.

FIG. 2 is a cross-sectional view of part II of FIG. 1 in a plane through a thermistor perpendicular to a vertical direction.

FIG. 3 is a cross-sectional view of part III-III of FIG. 1.

FIG. 4 is a cross-sectional view of part IV-IV of FIG. 1.

FIG. 5 is a diagram illustrating a manufacturing step of the temperature sensor according to the embodiment.

FIG. 6 is a diagram illustrating a manufacturing step of the temperature sensor according to the embodiment.

FIG. 7 is a diagram illustrating a temperature sensor according to a first comparative example.

FIG. 8 is a diagram illustrating a temperature sensor according to a second comparative example.

### DETAILED DESCRIPTION

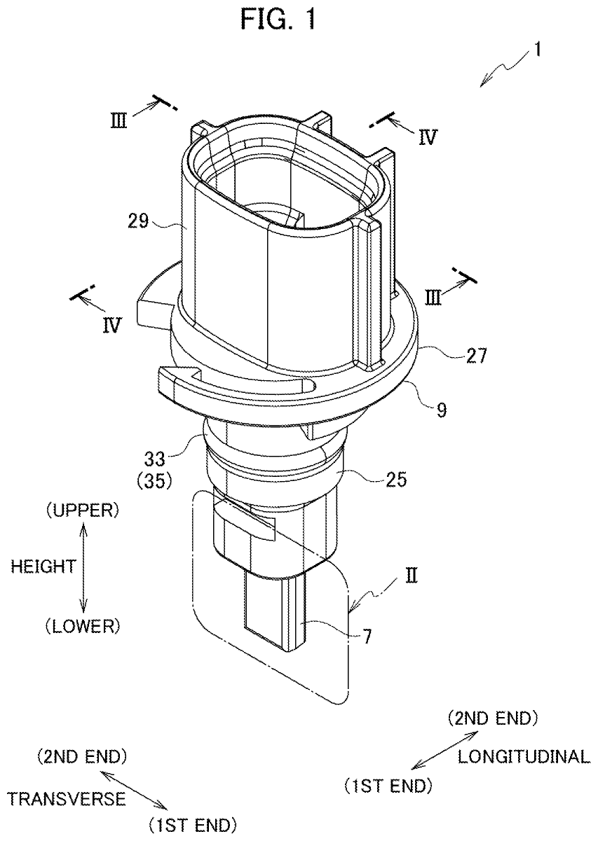

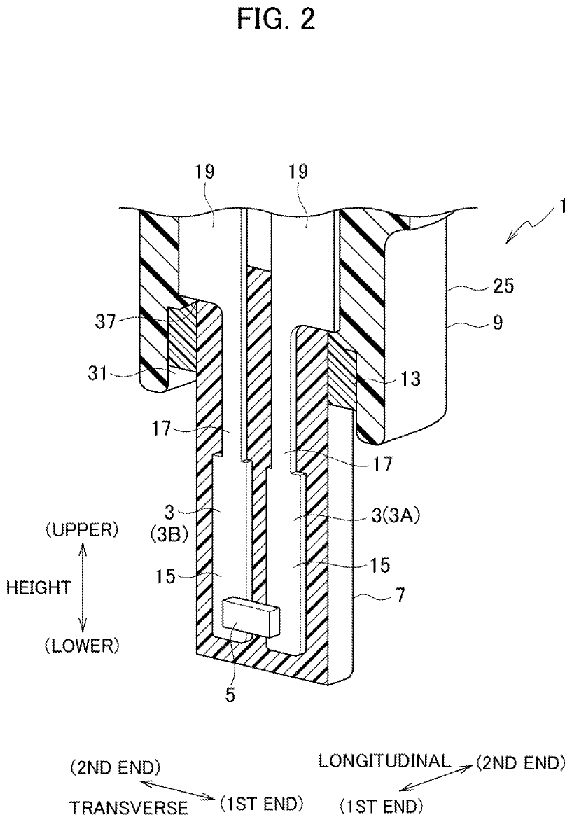

Hereinafter, a temperature sensor 1 according to an embodiment will be described in detail with reference to the drawings. The temperature sensor 1 according to the embodiment is installed and used at a mounting partner (not illustrated), and measures a temperature of a fluid such as an LLC (long life coolant). As illustrated in FIGS. 1 to 4, the temperature sensor 1 includes a pair of lead frames 3, a thermistor 5, a first resin part 7, and a second resin part 9.

Here, for convenience of explanation, in the temperature sensor 1, a predetermined direction is defined as a vertical direction, a predetermined direction orthogonal to the vertical direction is defined as a transverse direction, and a direction orthogonal to the vertical direction and the transverse direction is defined as a height direction. One end side in the vertical direction is defined as a first end side, and the other end side in the vertical direction is defined as a second end side. One end side in the transverse direction is defined as a first end side, and the other end side in the transverse direction is defined as a second end side. Further, one end side in the height direction is defined as an upper side, and the other end side in the height direction is defined as a lower side.

The pair of lead frames 3 are made of a conductive material such as metal, and each of the pair of lead frames 3 is elongated in the height direction, and both are aligned with each other in the transverse direction at a predetermined interval. The thermistor 5 is provided between the pair of lead frames 3 at a lower end part in the height direction of the pair of lead frames 3.

One end of the thermistor 5 is mechanically and electrically connected to a first lead frame 3A, which is one lead frame of the pair of lead frames 3. The other end of the thermistor 5 is mechanically and electrically connected to a second lead frame 3B, which is the other lead frame of the pair of lead frames 3.

The first resin part 7 is composed of an epoxy resin having insulation properties. The first resin part 7 covers the thermistor 5 and a portion of the pair of lead frames 3 near the thermistor 5 by directly contacting the thermistor 5 and the pair of lead frames 3 with a predetermined rigidity.

The epoxy resin is employed to facilitate transfer molding of the first resin part 7. By transfer molding, the first resin part 7 having a good accuracy of form and a position and posture of the pair of lead frames 3 relative to the first resin part 7 can be made accurate.

A thermal conductivity of the epoxy resin forming the first resin part 7 is as high as 0.8 W/m*K. The thermal conductivity of the epoxy resin may be as high as 0.3 W/m*K to 2.0 W/m*K. Furthermore, the value of the thermal conductivity of the first resin part 7 is larger than that of the second resin part 9.

The first resin part 7 is not a thin film but has a predetermined thickness with which the thermistor 5 and a portion of the pair of lead frames 3 near the thermistor 5 are covered. Thus, even if the lead frame 3 and the thermistor 5 do not exist, only the first resin part 7 is rigid enough to maintain the predetermined shape. In further explanation, the rigidity of the first resin part 7 is such that even if a person applies force to the first resin part 7 with a finger, the deformation can hardly be recognized by the naked eye.

The second resin part 9 is composed of a synthetic resin which is difficult to hydrolyze and having chemical resistance and toughness. For example, the second resin part 9 is composed of syndiotactic polystyrene resin (SPS resin). The thermal conductivity of the SPS resin is about 0.27 W/m*K.

The second resin part 9 covers a portion of the first resin part 7 and a part of the pair of lead frames 3 so that a portion of the first resin part 7 near the thermistor 5 is exposed. That is, the second resin part 9 is provided on the first resin part 7 and the pair of lead frames 3 by directly contacting a portion of the first resin part 7 (upper end in the height direction) and a part of the pair of lead frames 3 (middle part in the height direction). The second resin part 9 has insulation properties and has a predetermined rigidity similar to the first resin part 7.

The second resin part 9 is formed in a manner that an end (upper end) of the pair of lead frames 3 opposite to the thermistors 5 is exposed. The second resin part 9 is provided for installing the temperature sensor 1 on a mounting partner of the temperature sensor 1. Further, the second resin part 9 is provided for connecting a connector (not illustrated) to an exposed upper end of the pair of lead frames 3.

In further explanation, as described above, the pair of lead frames 3 extends in the height direction with the lead frames being slightly apart and parallel to each other. The thermistor 5 is provided at a lower end of the pair of lead frames 3 in the height direction. The first resin part 7 is provided at the lower end of the pair of lead frames 3 in the height direction and the thermistor 5, covering the pair of lead frames 3 and the thermistor 5.

The second resin part 9 is provided at an upper end of the first resin part 7 in the height direction and an intermediate part of the pair of lead frames 3 in the height direction. The second resin part 9 covers the first resin part 7 and the lead frame 3 so that a portion of the first resin part 7 near the thermistor 5 (a lower end and an intermediate portion of the first resin part 7 in the height direction) is exposed. In the height direction, the lower end of the second resin part 9 is positioned above the thermistor 5.

The upper end of the pair of lead frames 3 in the height direction is exposed without being covered with the first resin parts 7 and the second resin parts 9.

The temperature sensor 1 is provided with a potting agent 13. The potting agent 13 is provided at a boundary between the first resin part 7 and the second resin part 9. The potting agent 13 is provided for sealing an interface 37 between the first resin part 7 and the second resin part 9, and covers the interface 37.

The thermistor 5 is provided at one end of the pair of lead frames 3 (lower end of the lead frames 3 in the height direction) in the longitudinal direction (height direction).

The heat transfer is suppressed at the intermediate part of each of the pair of lead frames 3 in a longitudinal direction (height direction) relative to other portions of the pair of lead frames 3 in the longitudinal direction (lower part and upper part in height direction). That is, a value of the heat amount conducted by the intermediate part of each lead frame 3 is smaller than the value of the heat amount conducted by other parts in the longitudinal direction of each lead frame 3. In addition, the heat transfer may be suppressed at the intermediate part in the longitudinal direction (height direction) of at least one of the lead frames 3 relative to other parts of the pair of lead frames 3 in the longitudinal direction.

In further explanation, each of the pair of lead frames 3 is formed in an elongated rectangular plate-lake shape. A width direction of the lead frame 3 is the transverse direction, and a thickness direction of the lead frame 3 is the vertical direction. The pair of lead frames 3 are arranged slightly apart from each other in the width direction.

Although the entire lead frame 3 is made of the same material, a width dimension value of each of the pair of lead frames 3 is reduced over a predetermined length at an intermediate part 17 in the longitudinal direction (height direction) of the lead frames 7. Thereby, the heat transfer is suppressed at the intermediate part of the lead frame 3 in the longitudinal direction. It should be noted that, instead of reducing the value of the width dimension of the intermediate part, the shape of the intermediate part may be changed so that the area of the cross section of the intermediate part (a cross section made of a plane perpendicular to the longitudinal direction) is reduced. In addition, instead of or in addition to changing the shape of the intermediate part described above, the material of the intermediate part of the lead frame 3 in the longitudinal direction may be changed to one having a lower thermal conductivity than other parts of the lead frame 3. In addition, at least one of the lead frames 3 in the pair of lead frames 3 may have a smaller width dimension over a predetermined length in the intermediate part 17 in the longitudinal direction.

The temperature sensor 1 will now be described in more detail.

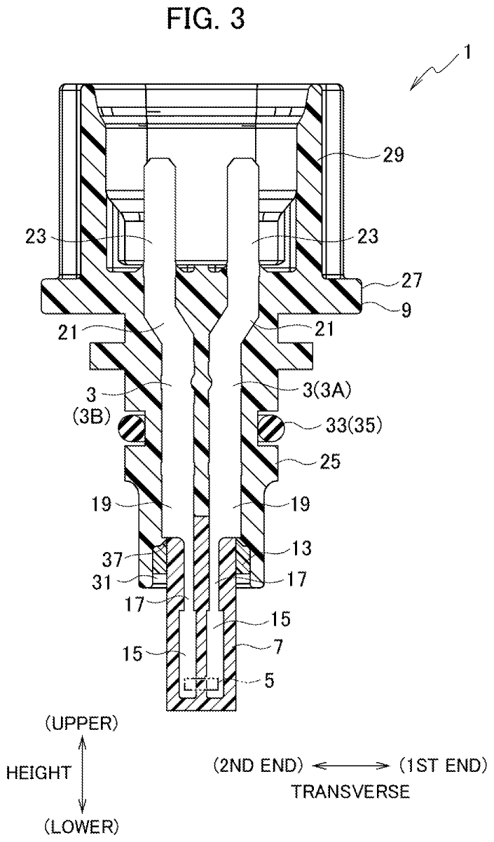

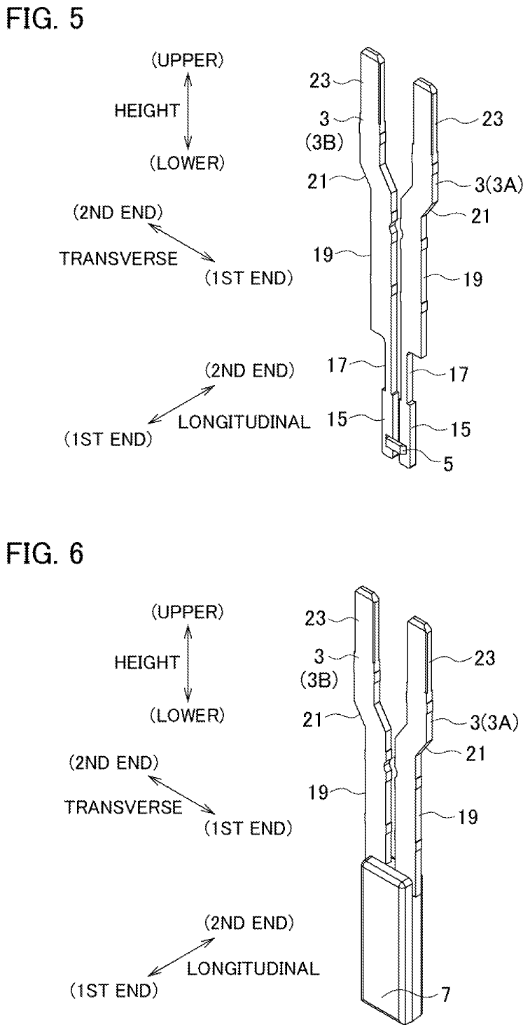

As illustrated in FIGS. 3 and 5, the first lead frame 3A includes a first portion 15, a second portion 17, a third portion 19, a fourth portion 21, and a fifth portion 23, and is generally formed in an elongated rectangular flat plate-like shape. The first lead frame 3A is obtained, for example, by applying a pressing process to a flat plate-like material.

The first portion 15 is formed in a rectangular flat plate-like shape extending in the height direction with a predetermined width and a predetermined thickness. The second portion 17 is also formed in a rectangular flat plate-like shape extending in the height direction with a predetermined width and a predetermined thickness. Further, the value of the width dimension of the second portion 17 is smaller than the value of the width dimension of the first portion 15, and the value of the height dimension of the second portion 17 is similar to the value of the height dimension of the first portion 15 or smaller than the value of the height dimension of the first portion 15.

The third portion 19 is also formed in a rectangular flat plate-like shape extending in the height direction with a predetermined width and a predetermined thickness. The value of the width dimension of the third portion 19 is larger than the value of the width dimension of the first portion 15, and the value of the height dimension of the third portion 19 is larger than the value of the height dimension of the first portion 15.

The fourth portion 21 is formed in a rectangular flat plate-like shape extending in a direction slightly inclined to the height direction with a predetermined width and a predetermined thickness. Further, the value of the width dimension of the fourth portion 21 is similar to the value of the width dimension of the third portion 19, and the value of the height dimension of the fourth portion 21 (a direction slightly inclined to the height direction) is smaller than the value of the height dimension of the second portion 17.

The fifth portion 23 is formed in a rectangular flat plate-like shape extending in the height direction with a predetermined width and a predetermined thickness. Further, the value of the width dimension of the fifth portion 23 is similar to the value of the width dimension of the third portion 19, and the value of the height dimension of the fifth portion 23 is larger than the value of the height dimension of the first portion 15 and smaller than the value of the height dimension of the third portion 19.

The first portion 15, the second portion 17, the third portion 19, the fourth portion 21, and the fifth portion 23 are arranged in this order from the lower side to the upper side in the height direction.

A position of an end of the first portion 15 in the width direction (the first side end in the transverse direction), a position of an end of the second portion 17 in the width direction (the first side end in the transverse direction), and a position of an end of the third portion 19 in the width direction (the first side end in the transverse direction) generally correspond to each other in the transverse direction.

Since the fourth portion 21 is arranged slightly oblique to the height direction, a position of an end of the fifth portion 23 in the width direction (the first side end in the transverse direction) is located more on the first end side in the transverse direction than a position of an end of the third portion 19 in the width direction (the first sideward end in the transverse direction).

The second lead frame 3B is formed in the same shape as the first lead frame 3A. The second lead frame 3B is slightly distant from the first lead frame 3A and is positioned on a second end side in the transverse direction relative to the first lead frame 3A. Further, the second lead frame 3B is symmetrically to the first lead frame 3A with respect to a central plane arranged perpendicular to the transverse direction and located in a center between the first lead frame 3A and the second lead frame 3B.

The thermistor 5 is provided at a lower end of a pair of first portions 15 in the height direction. Further, the thermistor 5 is provided on one surface of the lead frame 3 in the thickness direction (a surface of the first end side in the vertical direction). The thermistor 5, like the pair of lead frames 3A and 3B, is arranged symmetrically with respect to the central plane.

As illustrated in FIGS. 3 and 6, the outer shape of the first resin part 7 is formed in a long rectangular parallelepiped shape in the height direction, and covers all of the first portions 15 and all of the second portions 17 of the lead frame 3, and all of the thermistor 5. Further, the upper end of the first resin part 7 in the height direction is in contact with the lower end (both sides in the thickness direction of the lower end) of the third portion 19 of the lead frame 3, and covers the lower end.

A value of a transverse dimension of the first resin part 7 generally corresponds to a value of a dimension between an end face of the third portion 19 of the first lead frame 3A (an end face on the first end side of the transverse direction) and an end face of the third portion 19 of the second lead frame 3B (the end face on the second end side of the transverse direction).

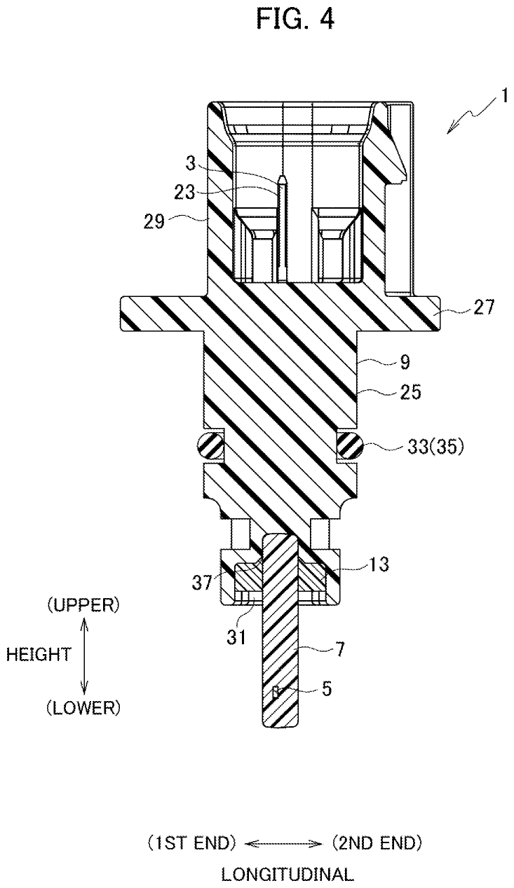

As illustrated in FIGS. 3 and 4, the second resin part 9 includes an insertion portion 25, a flange portion 27, and a cylindrical portion 29. The insertion portion 25, the flange portion 27, and the cylindrical portion 29 are arranged in this order from the lower side to the upper side.

The insertion portion 25 is a portion to be inserted into the mounting partner when the temperature sensor 1 is installed on the mounting partner (not illustrated). The flange portion 27 is a portion to abut an end face of the mounting partner when the temperature sensor 1 is installed on the mounting partner. The cylindrical portion 29 is a portion into which a connector enters when the upper end of the lead frame 3 is joined to the connector (not illustrated).

As illustrated in FIG. 3, a recess 31 is formed in a lower end of the insertion portion 25. The insertion portion 25 contacts and covers a lower portion of the fifth portion 23, the fourth portion 21, and the third portion 19 of the lead frame 3. Since the recess 31 is formed, an annular gap is formed between the insertion portion 25 and the first resin part 7.

An annular groove 33 is provided on an outer periphery of the intermediate part in the height direction of the insertion portion 25, and an annular sealing member (for example, an O-ring) 35 is provided in the groove 33.

An interface 37 between the first resin part 7 and the second resin part 9 is formed on an upper end of the recess 31. When the temperature sensor 1 is viewed from the lower side to the upper side, the interface 37 is formed in an annular shape at an outer periphery of the first resin part 7. The potting agent 13 is provided in the recess 31 and contacts the first resin part 7 and the second resin part 9 to cover all of the interface 37.

A manufacturing method of the temperature sensor 1 will be described. The manufacturing method of the temperature sensor 1 includes a thermistor installation step, a first resin part installation step, and a second resin part installation step.

In the thermistor installation step, the thermistor 5 is installed on the pair of lead frames 3 (see FIG. 5).

In the first resin part installation step, the first resin part 7 having a predetermined rigidity is provided by transfer molding after the thermistor 5 is installed on the pair of lead frames 3 in the thermistor installation step. In further explanation, in the first resin part installation step, the thermistor 5 and a portion of the pair of lead frames 3 near the thermistor 5 are covered with epoxy resin by transfer molding, thereby providing the first resin part 7 (see FIG. 6).

In the second resin part installation step, the second resin part 9 is provided by insert molding after the first resin part 7 is provided in the first resin part installation step. In further explanation, in the second resin part installation step, the second resin part 9 is provided for covering a portion of the first resin part 7 and a part of a pair of lead frames 3 by insert molding so that a portion of the first resin part 7 near the thermistor 5 is exposed.

The manufacturing method of the temperature sensor 1 includes a potting agent installation step. In the potting agent installation step, the potting agent 13 having insulation properties is provided for covering an interface 37 between the first resin part 7 and the second resin part 9 after the second resin part 9 is provided in the second resin part installation step.

The temperature sensor 1 includes the thermistor 5 provided on the pair of lead frames 3 and the first resin part 7. The first resin part 7 is composed of an epoxy resin, and covers the thermistor 5 and a part of the pair of lead frames 3 near the thermistor 5 with predetermined rigidity.

Further, the temperature sensor 1 includes the second resin part 9 covering a portion of the first resin part 7 and a part of the pair of lead frames 3 so that a portion of the first resin part 7 near the thermistor 5 is exposed.

With this structure, the strength of the temperature sensor 1 is increased, and since the thermistor 5 detects heat flowing only through the first resin part 7 having high thermal conductivity, the responsiveness and temperature measurement accuracy are improved.

That is, an exterior of the thermistor 5 (the first resin part 7 provided by transfer molding) comes into direct contact with the detection medium (for example, LLC). Further, the thermal resistance of the first resin part 7 at a portion covering the thermistor 5 is reduced, and the heat can be efficiently transferred to the thermistor 5 in the shortest distance and in a short time. Thus, the temperature response is improved, and the temperature measurement accuracy is improved.

In the temperature sensor 1, since the pair of lead frames 3 and the thermistor 5 are covered with a layer of first resin part 7, the number of parts is reduced and the structure of the temperature sensor 1 is simplified, thereby improving the manufacturability.

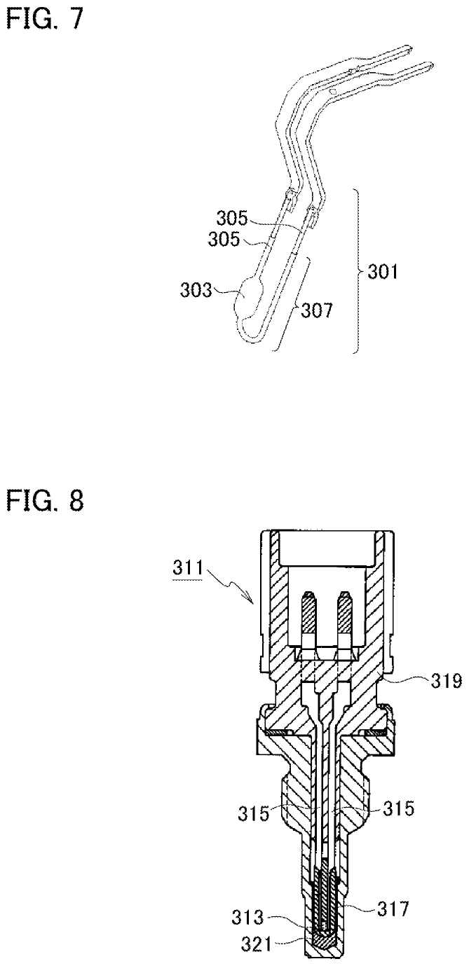

A temperature sensor 301 according to a first comparative example will be described with reference to FIG. 7. In the temperature sensor 301, a thermistor 303 and a lead wire 305 are coated with an epoxy resin 307 with excellent heat resistance and chemical resistance.

In the temperature sensor 301, a thickness of the epoxy resin 307 to which a coating is applied is extremely reduced, so that the strength of the temperature sensor 301 is reduced.

Next, a temperature sensor 311 according to a second comparative example will be described with reference to FIG. 8. In the temperature sensor 311 according to the second comparative example, a lead wire portion 315 is connected to a thermistor 313, and both are sealed by a sealing layer 317. Further, the sealing layer 317 is connected to a resin base 319, and a heat transfer agent 321 is provided in a gap between the sealing layer 317 and the resin base 319.

The temperature sensor 311 according to the second comparative example has poor responsiveness since heat flowing through three layers of the resin base 319, the heat transfer agent 321, and the sealing layer 317 is detected by the thermistor 313.

In the temperature sensor 1 according to the embodiment, the heat transfer is suppressed at the intermediate part of the lead frame 3 in the vertical direction (height direction) relative to other portions in the vertical direction of the lead frame 3.

As a result, the amount of heat radiation transmitted through the lead frame 3 from the thermistor 5 to the opposite side (upper side) of the thermistor 5 can be reduced, and the temperature response is further improved.

In the temperature sensor 1, a width dimension of the pair of lead frames 3 is reduced at the middle portion (second portion) 17 in the vertical direction. As a result, the intermediate portion 17 in the vertical direction of the lead frame 3 is narrowed, and the amount of heat radiation from the thermistor 5 to the opposite side (upper side) of the thermistor through the lead frame 3 can be reduced, thereby improving the responsiveness with respect to temperature.

In the portions of the lead frame 3 excluding the intermediate portion 17 in the longitudinal direction, the width dimension is increased, and the lead frame 3 is thickened. Thus, the strength of the lead frame 3 can be sufficiently secured.

Further, in the temperature sensor 1, the lead frame 3 is formed in an elongated rectangular plate-like shape, so that the lead frame 3 can be easily molded.

The manufacturing method of the temperature sensor 1 includes the thermistor installation step, the first resin part installation process, and the second resin part installation process. In the first resin part installation step, the first resin part 7 is provided by covering the thermistor 5 and a part of the lead frame 3 with an epoxy resin by transfer molding.

Thus, it is possible to obtain a transfer part (the first resin part 7 and a portion of the thermistor 5 and the lead frame 3 covered with the first resin part 7) having high dimensional accuracy and high strength, and it is easy to provide the second resin part 9 by stable insert molding. Then, the manufacturability of the temperature sensor 1 is improved.

Further, by passing through the thermistor installation step, the first resin part installation step, the second resin part installation step, and the potting agent installation step, the temperature sensor 1 is completed, so that the number of components of the temperature sensor 1 is reduced and the structure is simplified.

Although the present embodiment has been described above, the present embodiment is not limited to these, and various modifications can be made within the scope of the gist of the present embodiment.

1. A temperature sensor, comprising:
a pair of lead frames;
a thermistor provided on the pair of lead frames;
a first resin part composed of an epoxy resin and covering the thermistor and a part of the pair of lead frames near the thermistor with predetermined rigidity; and
a second resin part covering a portion of the first resin part and a part of the pair of lead frames so that a portion of the first resin part near the thermistor is exposed, wherein
a thermal conductivity of the first resin part is larger than a thermal conductivity of the second resin part.

2. The temperature sensor according to claim 1, wherein
each of the pair of lead frames is elongated,
the thermistor is provided at one end of the pair of lead frames in a longitudinal direction, and
a heat transfer is suppressed at an intermediate part of at least one of the pair of lead frames in a longitudinal direction relative to other portions of the pair of lead frames in the longitudinal direction.

3. The temperature sensor according to claim 1, wherein
each of the pair of lead frames is formed in an elongated rectangular plate-like shape,
the pair of lead frames are arranged slightly apart from each other in a width direction,
the thermistor is provided at one end of the pair of lead frames in the longitudinal direction, and
a width dimension value of at least one of the pair of lead frames is reduced at an intermediate part in a longitudinal direction of the lead frames.

4. A method for manufacturing a temperature sensor, comprises:
installing a thermistor on a pair of lead frames;
providing a first resin part having a predetermined rigidity by covering the thermistor and a portion of the pair of lead frames near the thermistor with epoxy resin by use of transfer molding after the thermistor is installed on the pair of lead frames; and
providing a second resin part covering a portion of the first resin part and a part of the pair of lead frames by use of insert molding so that a portion of the first resin part near the thermistor is exposed after the first resin part is provided, wherein
a thermal conductivity of the first resin part is larger than a thermal conductivity of the second resin part.
